(19) United States
(12) Patent Application Publication
(10) Pub. No.: US 2017/0110754 A1
(43) Pub. Date: Apr. 20, 2017

(54) FUEL CELL STACK

(71) Applicant: HONDA MOTOR CO., LTD., Tokyo (JP)

(72) Inventors: Tadashi NISHIYAMA, Wako (JP); Tsuyoshi KOBAYASHI, Wako (JP)

(73) Assignee: HONDA MOTOR CO., LTD., Tokyo (JP)

(21) Appl. No.: 15/292,120

(22) Filed: Oct. 13, 2016

(30) Foreign Application Priority Data
Oct. 14, 2015 (JP) 2015-203007

(51) Int. Cl. H01M 8/2465; H01M 8/1018

(52) U.S. Cl. CPC H01M 8/2465; H01M 8/1018; H01M 2250/20

(57) ABSTRACT

A fuel cell stack includes a stack body, an end plate, an end stack member, a terminal plate, and a fixing member. The stack body has an end portion in a stacking direction. The stack body includes power generating cells stacked in the stacking direction. The end stack member is provided between the end plate and the end portion of the stack body in the stacking direction. The terminal plate is provided between the end stack member and the end portion of the stack body in the stacking direction to be in contact with the end portion of the stack body. The terminal plate includes a terminal bar which passes through the end stack member and the end plate and which has a projecting portion projecting from the end plate to be connected to a cable connecter. The fixing member connects the cable connecter to the end stack member.

### CROSS-REFERENCE TO RELATED APPLICATIONS

The present application claims priority under 35 U. S. C. §119 to Japanese Patent Application No. 2015-203007, filed Oct. 14, 2015. The contents of this application are incorporated herein by reference in their entirety.

### BACKGROUND OF THE INVENTION

Field of the Invention

The present invention relates to a fuel cell stack.

Discussion of the Background

Generally, a solid polymer electrolyte fuel cell employs a solid polymer electrolyte membrane formed of a polymer ion exchange membrane. The fuel cell has an electrolyte membrane and electrode structure (MEA=membrane electrode assembly) which includes an anode electrode arranged on one surface of the solid polymer electrolyte membrane and a cathode electrode arranged on the other surface of the solid polymer electrolyte membrane. The anode electrode and the cathode electrode have a catalyst layer (electrode catalyst layer) and a gas diffusion layer (porous carbon), respectively.

The electrolyte membrane and electrode structure is held between a cathode separator and an anode separator so as to form a power generating cell (unit fuel cell). Oxidant gas flows through the cathode separator along an electrode surface and fuel gas flows through the anode separator along the electrode surface. A predetermined number of power generating cells is stacked and used as a fuel cell stack for a vehicle, for example.

The fuel cell stack has a terminal plate, an insulator (insulating plate) and an end plate arranged on both ends in the stacking direction of a stack body which is formed by stacking a plurality of power generating cells. The terminal plate includes a terminal bar (electric power collecting terminal) which extends in the stacking direction in order for collecting electric power from the stack body and conducting it to the outside. The terminal bar is electrically connected through a cable to a contactor (or relay) so as to supply the electric power to an external load such as a motor and the like.

As an example, Japanese Unexamined Patent Application Publication No. 2008-204939 discloses a fuel cell system. In this fuel cell system, one end of an electrically conductive member is electrically connected to one of the power collecting terminals. The electrically conductive member bends and extends in the direction of an endplate surface which intersects the power collecting terminal. The cable which extends toward the other of the power collecting terminals is electrically connected to the other end of the electrically conductive member.

Therefore, members such as a cable and the like are not curved to project from the endplate to the outside in the stacking direction. Accordingly, the space required for arranging the entire fuel cell system is reduced easily and the degree of freedom in layout can be increased.

### SUMMARY OF THE INVENTION

According to one aspect of the present invention, a fuel cell stack includes a stack body in which power generating cells configured to generate power by electrochemical reaction of fuel gas and oxidant gas are stacked in a plurality of layers, a terminal plate, an end stack member and an endplate which are arranged toward outside in the stacking direction of the stack body. The terminal plate has a terminal bar which passes through the end plate and extends outwardly in the stacking direction so as to project outwardly of the end plate. A fixing member is provided to fixedly secure a cable connecter connected to the terminal bar, to the end stack member.

According to another aspect of the present invention, a fuel cell stack includes a stack body, an end plate, an end stack member, a terminal plate, and a fixing member. The stack body has an end portion in a stacking direction. The stack body includes power generating cells stacked in the stacking direction. The power generating cells are configured to generate power via electrochemical reaction of fuel gas and oxidant. The end stack member is provided between the end plate and the end portion of the stack body in the stacking direction. The terminal plate is provided between the end stack member and the end portion of the stack body in the stacking direction to be in contact with the end portion of the stack body. The terminal plate includes a terminal bar which passes through the end stack member and the end plate and which has a projecting portion projecting from the end plate to be connected to a cable connecter. The fixing member connects the cable connecter to the end stack member.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of a fuel cell stack in accordance with an embodiment of the present invention;

FIG. 2 is a partially exploded schematic perspective view of the fuel cell stack;

FIG. 3 is a partially omitted cross sectional view of the fuel cell stack;

FIG. 4 is an exploded perspective view of a power generating cell constituting the fuel cell stack;

FIG. 5 is a cross sectional view schematically showing one end side of the fuel cell stack;

FIG. 6 is a cross sectional view of the fuel cell stack as a comparative example;

FIG. 7 is an explanatory diagram of movement when an external load is applied to the fuel cell stack according to a comparative example; and

FIG. 8 is an explanatory diagram of movement when the external load is applied to the fuel cell stack according to the embodiment of the present invention.

### DESCRIPTION OF THE EMBODIMENTS

The embodiments will now be described with reference to the accompanying drawings, wherein like reference numerals designate corresponding or identical elements throughout the various drawings.

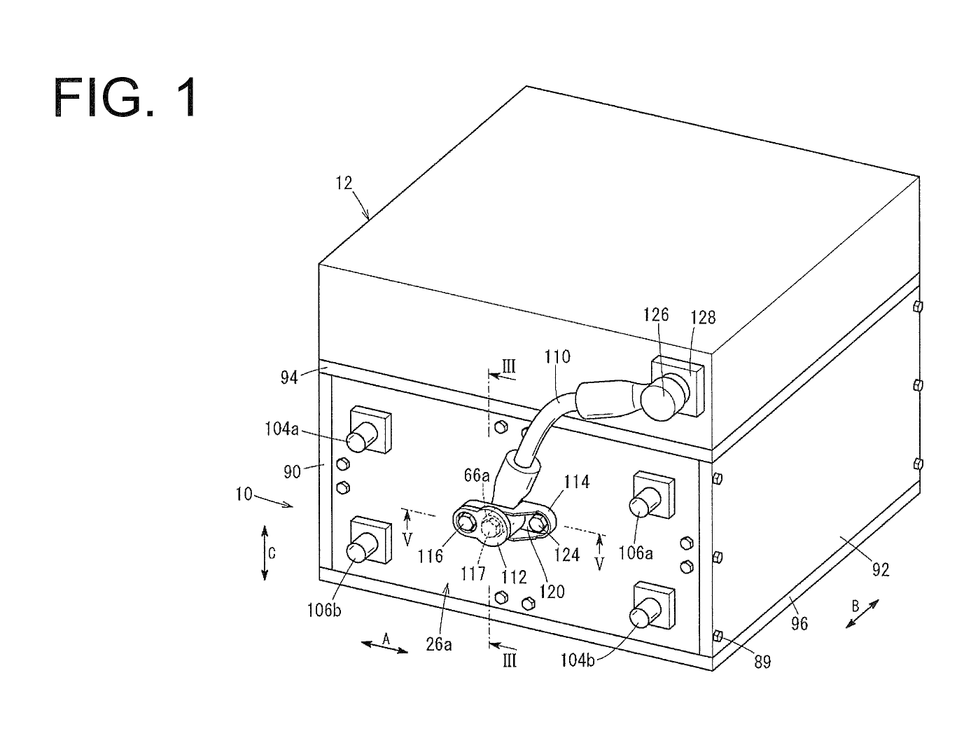

As shown in FIG. 1, a fuel cell stack 10 according to an embodiment of the present invention is mounted into a fuel cell powered electric vehicle (not shown), for example, as an onboard fuel cell stack. A control device 12 is arranged on an upper part of the fuel cell stack 10. The control device 12 constitutes a voltage control unit (VCU) for controlling an output of the fuel cell stack 10, for example.

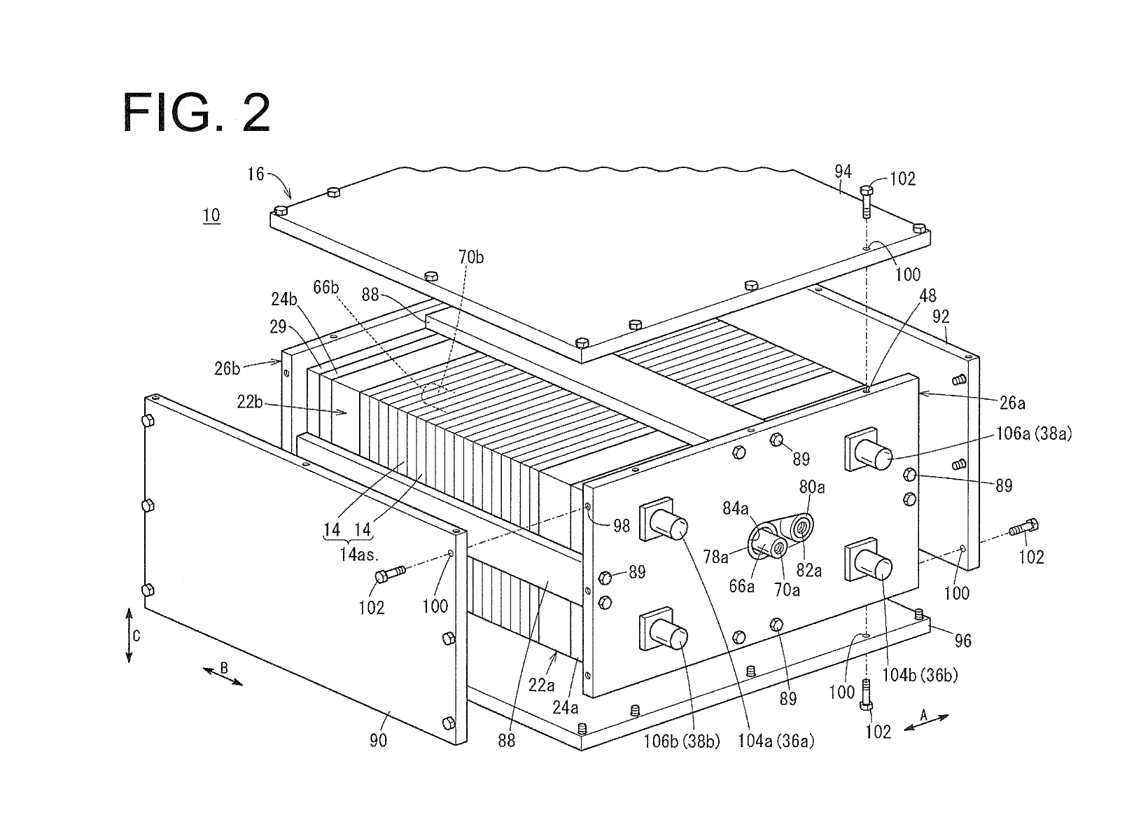

As shown in FIG. 2, the fuel cell stack 10 is provided with a stack body 14as. in which a plurality of power generating cells 14 are stacked in the horizontal direction (the direction of an arrow B) or in the vertical direction (the direction of an arrow C). The stack body 14as. is accommodated in a housing 16.

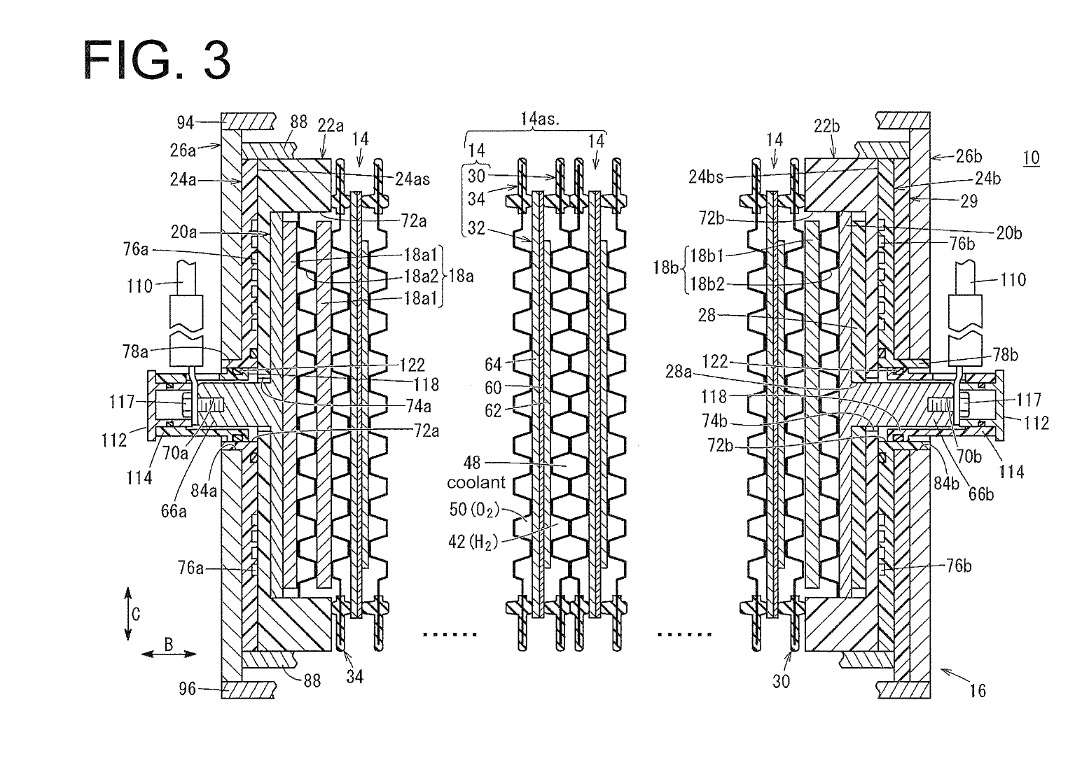

As shown in FIG. 3, on one end in the stacking direction of the stack body 14as., an electroconductive heat insulation member 18a, a terminal plate 20a, an insulating member 22a, a temperature controlling plate 24a and an end plate 26a are arranged in the order named toward outside in the stacking direction. At least one of the insulating member 22a and the temperature controlling plate 24a constitutes an end stack member. The end stack member is made of electric insulating material.

On the other end in the stacking direction of the stack body 14as., an electroconductive heat insulation member 18b, a terminal plate 20b, a resin spacer 28, an insulating member 22b, a temperature controlling plate 24b, a resin plate 29 and an end plate 26b are arranged in the order named toward outside in the stacking direction. At least one of the insulating member 22b, the temperature controlling plate 24b and the resin plate 29 constitutes an end stack member. The end stack member is made of an electric insulating material.

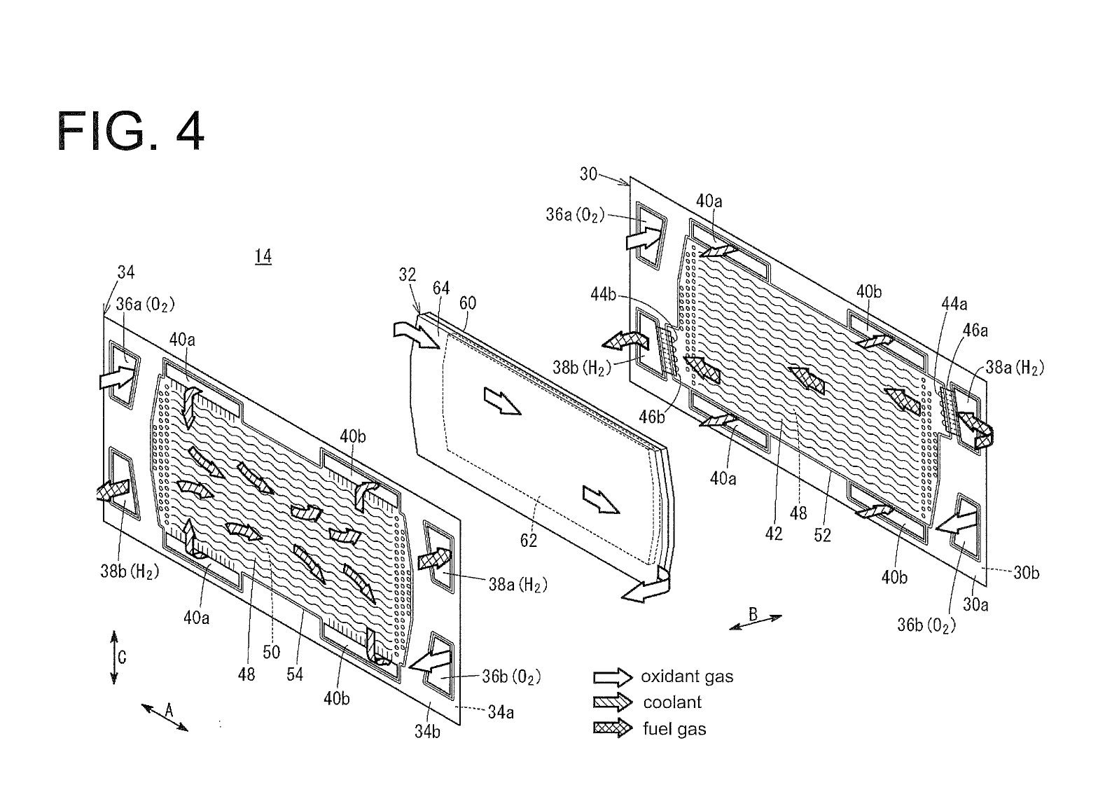

The power generating cell 14, as shown in FIGS. 3 and 4, includes an anode separator 30, an electrolyte membrane and electrode structure (MEA) 32 and a cathode separator 34. The anode separator 30 and the cathode separator 34 are made of an elongated metal plate such as a steel plate, a stainless steel plate, an aluminum plate, an electroplated steel plate and the like, for example.

Moreover, instead of a metal separator, a carbon separator may be used for the anode separator 30 and the cathode separator 34. In addition, the power generating cell 14 may be formed by stacking a first separator, a first membrane electrode assembly, a second separator, a secondmembrane electrode assembly and a third separator. Moreover, the power generating cell 14 may have three or more membrane electrode assemblies and five or more separators.

As shown in FIG. 4, on one end portion in the long side direction (the direction of the arrow B) (the horizontal direction) of the power generating cell 14, there are provided an oxidant gas inlet communication hole 36a and a fuel gas outlet communication hole 38b which are communicated with each other in the direction of the arrow B corresponding to the stacking direction. The oxidant gas inlet communication hole 36a is configured to supply the oxidant gas, for example, such as oxygen containing gas. The fuel gas outlet communication hole 38b is configured to discharge the fuel gas, for example, such as hydrogen containing gas.

On the other end portion in the long side direction (the direction of the arrow A) of the power generating cell 14, a fuel gas inlet communication hole 38a for supplying the fuel gas, and an oxidant gas outlet communication hole 36b for discharging the oxidant gas are provided while being communicated with each other in the direction of the arrow B.

On one (on the side of the oxidant gas inlet communication hole 36a) of end portions in the short side direction (the direction of the arrow C) (the vertical direction) of the power generating cell 14, a pair of upper and lower coolant inlet communication holes 40a is provided for supplying a coolant in a state of being communicated with each other in the direction of the arrow 13. On the other (on the side of the fuel gas inlet communication hole 38a) of the end portions in the short side direction of the power generating cell 14, a pair of upper and lower coolant outlet communication holes 40b is provided for discharging the coolant in a state of being communicated with each other in the direction of the arrow B.

On a surface 30a facing toward the electrolyte membrane and electrode structure 32 of the anode separator 30, there is formed a fuel gas flow passage 42 which provides communication between the fuel gas inlet communication hole 38a and the fuel gas outlet communication hole 38b. The fuel gas flow passage 42 has a plurality of corrugated flow passage grooves (or linear flow passage grooves).

The fuel gas inlet communication hole 38a and the fuel gas flow passage 42 are communicated with each other through a plurality of inlet connecting flow passages 44a. On the other hand, the fuel gas outlet communication hole 38b and the fuel gas flow passage 42 are communicated with each other through a plurality of outlet connecting flow passages 44b. The inlet connecting flow passages 44a and the outlet connecting flow passages 44b are covered with a lid 46a and a lid 46b.

A portion of a coolant flow passage 48 which provides communication between a pair of coolant inlet communication holes 40a and a pair of coolant outlet communication holes 40b is formed on a surface 30b of the anode separator 30.

On a surface 34a of the cathode separator 34 facing toward the electrolyte membrane and electrode structure 32, there is formed an oxidant gas flow passage 50 which provides communication between the oxidant gas inlet communication hole 36a and the oxidant gas outlet communication hole 36b. The oxidant gas flow passage 50 has a plurality of corrugated flow passage grooves (or linear flow passage grooves). A portion of the coolant flow passage 48 is formed on a surface 34b of the cathode separator 34.

On the surfaces 30a and 30b of the anode separator 30 there is integrally molded a first seal member 52 which surrounds an outer circumferential edge portion of the anode separator 30. On the surfaces 34a and 34b of the cathode separator 34 there is integrally molded a second seal member 54 which surrounds an outer circumferential edge portion of the cathode separator 34.

The first seal member 52 and the second seal member 54 are made of a seal material such as EPDM, NBR, fluorine containing rubber, silicone rubber, fluorosilicone robber, butyl rubber, natural rubber, styrene rubber, chloroprene rubber, acrylic rubber and the like or an elastic seal member such as cushion material, packing material and the like.

As shown in FIGS. 3 and 4, the electrolyte membrane and electrode structure 32 is provided with a solid polymer electrolyte membrane 60 which is a perfluorosulfonic acid membrane containing water, for example. The solid polymer electrolyte membrane 60 is held between the anode electrode 62 and the cathode electrode 64. Although the anode electrode 62 forms a step MEA which has a smaller plane dimension than that of the cathode electrode 64, it may have a larger plane dimension than that of the cathode electrode 64. In addition, the anode electrode 62 and the cathode electrode 64 may be configured to have the same plane dimension.

The anode electrode 62 and the cathode electrode 64 have a gas diffusion layer (not shown) consisting of a carbon paper or the like and an electrode catalyst layer (not shown) which is formed by uniformly applying porous carbon particles on each surface carried with a platinum alloy, to a surface of the gas diffusion layer. The electrode catalyst layer is formed on both surface of the solid polymer electrolyte membrane 60.

As shown in FIG. 3, in a position spaced apart from the center (or position located in the center) within a surface of each of the terminal plates 20a, 20b, there are provided terminal bars (electric power collecting terminals) 66a, 66b which extend outwardly in the stacking direction and project outwardly from the endplates 26a, 26b. Screw holes 70a, 70b are formed at a predetermined depth in the central positions of the terminal bars 66a, 66b.

The insulating members 22a, 22b are made of polycarbonate (PC), phenol resin or the like, for example. A rectangular recess 72a is provided in a central part of a surface of the insulating member 22a facing toward the terminal plate 20a. An opening 74a for inserting the terminal bar 66a of the terminal plate 20a therethrough is connected to the recess 72a.

The electroconductive heat insulation member 18a and the terminal plate 20a are accommodated in the recess 72a of the insulating member 22a. The electroconductive heat insulation member 18a is formed by sandwiching one second heat insulation member 18a2 between two first heat insulation members 18a1, for example. The first heat insulation member 18a1 is made of a carbon plate, for example, while the second heat insulation member 18a2 is made of a metal plate, for example. The metal plate is of a concave-convex shape in cross section so as to be spaced apart to provide air chambers in between.

The electroconductive heat insulation member 18b, the terminal plate 20b and the resin spacer 28 are accommodated in a recess 72b of the insulating member 22b. The electroconductive heat insulation member 18b is provided with one first heat insulation member 18b1 and one second heat insulation member 18b2.

Moreover, the electroconductive heat insulation members 18a, 18b are formed by a member which retains through-holes and has the electroconductive characteristic, and may be made of any of electroconductive foaming metal, honeycomb shaped metal (honeycomb member) and porous carbon (for example, carbon paper).

The rectangular recess 72b is provided in the central part of the surface of the insulating member 22b which faces toward the terminal plate 20b, and an opening 74b into which the terminal bar 66b of the terminal palate 20b is inserted is communicated with the recess 72b. An opening 28a into which the terminal bar 66b is inserted is formed in the resin spacer 28.

Coolant passages 76a for circulating a temperature controlling medium, for example, such as coolant are formed on a surface 24as of the temperature controlling plate 24a facing toward the insulating member 22a. The coolant passages 76a are communicated with one of the coolant inlet communication holes 40a and one of the coolant outlet communication holes 40b, and have a plurality of meandering coolant passage grooves. Coolant passages 76b are formed on a surface 24bs of the temperature controlling plate 24b facing toward the insulating member 22b. The coolant passages 76b are communicated with one (or the other) of the coolant inlet communication holes 40a and one (or the other) of the coolant outlet communication holes 40b, and have a plurality of meandering coolant passage grooves.

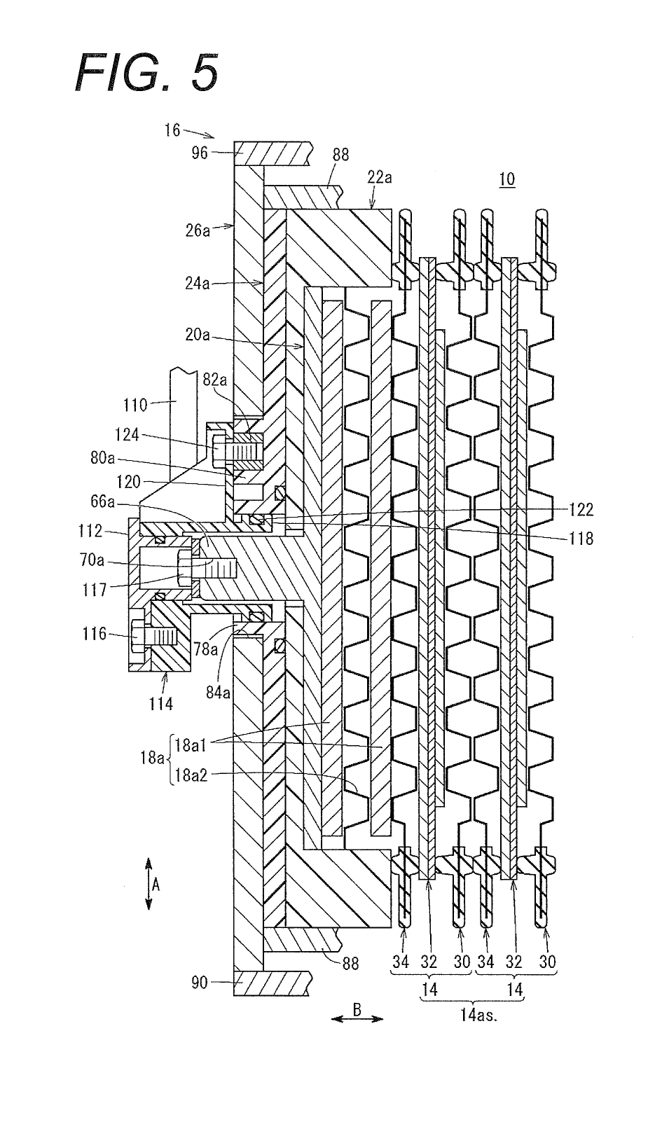

As shown in FIGS. 3 and 5, on the surface of the temperature controlling plate 24a opposite to the surface 24as which is the insulating member 22a side, a cylindrical part 78a is formed in such a way as to be coaxial with the terminal bar 66a and projects outwardly in the stacking direction. In the temperature controlling plate 24a, a cylindrical part 80a is formed in the vicinity of the cylindrical part 78a so as to project outwardly in the stacking direction. The cylindrical part 80a is provided with a female screw portion (helical insert) 82a. The end plate 26a is formed with an opening part 84a into which the cylindrical part 78a and the cylindrical part 80a are inserted advanceably and retreatably (movable back and forth) in the direction of the arrow B. The opening part 84a may be formed with an opening part for inserting the cylindrical part 78a and an opening for inserting the cylindrical part 80a, separately.

As shown in FIG. 3, the temperature controlling plate 24b is formed in a similar structure to the above referred temperature controlling plate 24a. Therefore, the same elements are given the same reference numerals while affixing a character b to the reference numerals instead of a character a, and detailed description will be omitted.

As shown in FIG. 2, connecting bars 88 each of which has a predetermined length corresponding to central positions of the end plates are arranged to extend between each side of the end plate 26a and each side of the end plate 26b. The distance between the end plates 26a and 26b is maintained constant. Both ends of the connecting bar 88 are fixedly secured to the end plates 26a, 26b by screws 89 so as to apply fastening loads in the stacking direction (the direction of the arrow B) to the plurality of stacked power generating cells 14.

Two sides (surfaces) of the housing 16 located on both ends in the stacking direction (the direction of the arrow B) are formed by the end plates 26a, 26b. Two sides (surfaces) of the housing 16 located on both ends in the direction of the arrow A are formed by a front side panel 90 and a rear side panel 92 each of which is formed in a horizontally long shape. Two sides (surfaces) of the housing 16 located on both ends in the direction of the arrow C are formed by an upper side panel 94 and a lower side panel 96. The upper side panel 94 and the lower side panel 96 have a horizontally long plate shape.

The front side panel 90, the rear side panel 92, the upper side panel 94 and the lower side panel 96 are fixedly secured by screwing each screw 102 through each hole 100 into each tapped hole 98 provided in lateral portions of the end plates 26a, 26b. The control device 12 is fixed on the upper side panel 94 (see FIG. 1).

As shown in FIGS. 1 and 2, an oxidant gas supply manifold 104a, an oxidant gas discharge manifold 104b, a fuel gas supply manifold 106a and a fuel gas discharge manifold 106b are mounted on the end plate 26a. The oxidant gas supply manifold 104a is communicated with the oxidant gas inlet communication hole 36a of each of the power generating cells 14, and the oxidant gas discharge manifold 104b is communicated with the oxidant gas outlet communication holes 36b of the power generating cells 14.

The fuel gas supply manifold 106a is communicated with the fuel gas inlet communication hole 38a of each of the power generating cells 14, and the fuel gas discharge manifold 106b is communicated with the fuel gas outlet communication holes 38b of the power generating cells 14.

On the end plate 26b there are mounted a coolant supply manifold (not shown) which is integrally communicated with the pair of coolant inlet communication holes 40a and a coolant discharge manifold (not shown) which is integrally communicated with the pair of coolant outlet communication holes 40b.

Although not shown in the drawings, the pair of coolant inlet communication holes 40a and the pair of coolant outlet communication holes 40b are formed in each of the insulating member 22a, 22b, the temperature controlling plate 24a, 24b and the end plate 26b. Each of the oxidant gas inlet communication hole 36a, the oxidant gas outlet communication hole 36b, the fuel gas inlet communication hole 38a and the fuel gas outlet communication hole 38b is formed in the insulating member 22a, the temperature controlling plate 24a and the end plate 26a.

As shown in FIGS. 1, 3 and 5, a cable connector 112 which is connected to one end of a high voltage cable 110 is fixedly secured to the terminal bar 66a of the fuel cell stack 10 through a fixing member 114. As shown in FIGS. 3 and 5, the cable connector 112 is fixedly secured to the fixing member 114 through a screw 116. The cable connector 112 is electrically connected to the terminal bar 66a by having a connecting screw 117 screwed into a screw hole 70a of the terminal bar 66a.

As shown in FIG. 5, the fixing member 114 is provided with an engaging section 118 and a mounting plate section 120. The engaging section 118 has an O-ring 122 placed on an outer circumference thereof and is in fitting engagement with an inner circumferential surface of the cylindrical part 80a of the temperature controlling plate 24a. A fixing screw 124 to be inserted into the mounting plate section 120 is screwed into the female screw portion 82a, so that the fixing member 114 is fixedly secured to the temperature controlling plate 24 constituting the end stack member.

As shown in FIG. 1, a cable connector 126 connected to the other end of the high voltage cable 110 is electrically connected to the control device 12 through a fixing member 128. Although not shown in the drawings, the terminal bar 66b side is constituted in a similar structure to the terminal bar 66a side.

The operation of the fuel cell stack 10 constituted as above will be described hereunder.

First, as shown in FIGS. 1 and 2, in the end plate 26a, the oxidant gas such as oxygen containing gas or the like is supplied to the oxidant gas supply manifold 104a, and the fuel gas such as hydrogen containing gas or the like is supplied to the fuel gas supply manifold 106a. On the other hand, in the end plate 26b, the coolant such as demineralized water, ethylene glycol, oil or the like is supplied to the coolant supply manifold although not shown in the drawings.

Therefore, the oxidant gas, as shown in FIG. 4, is introduced from the oxidant gas inlet communication hole 36a to the oxidant gas flow passage 50 of the cathode separator 34. The oxidant gas flows in the direction of the arrow A thereby to be supplied to the cathode electrode 64 of the electrolyte membrane and electrode structure 32.

On the other hand, the fuel gas is introduced from the fuel gas inlet communication hole 38a to the fuel gas flow passage 42 of the anode separator 30. The fuel gas flows along the fuel gas flow passage 42 in the direction of the arrow A thereby to be supplied to the anode electrode 62 of the electrolyte membrane and electrode structure 32.

Accordingly, in the electrolyte membrane and electrode structure 32, the oxidant gas supplied to the cathode electrode 64 and the fuel gas supplied to the anode electrode 62 are consumed within the electrode catalyst layer by the electrochemical reaction so as to generate the electric power, so that the electric power is generated in each of the power generating cells 14.

Next, the oxidant gas supplied to and consumed in the cathode electrode 64 is discharged along the oxidant gas outlet communication hole 36b in the direction of the arrow B. The oxidant gas, as shown in FIGS. 1 and 2, is discharged out of the oxidant gas discharge manifold 104b of the end plate 26a. Similarly, the fuel gas supplied to and consumed in the anode electrode 62 is discharged along the fuel gas outlet communication hole 38b in the direction of the arrow B. The fuel gas is discharged out of the fuel gas discharge manifold 106b of the end plate 26a.

Further, as shown in FIG. 4, the coolants supplied to each of the coolant inlet communication holes 40a are introduced into the coolant flow passage 48 formed between the anode separator 30 and the cathode separator 34. The coolants flow in the direction of the arrow C while coming close to each other. The coolants flow further in the direction of the arrow A (the long side direction of the separator) so as to cool the electrolyte membrane and electrode structure 32.

Then, the coolants flow in the direction of the arrow C while being separated apart from each other and are discharged out of each of the coolant outlet communication holes 40b. The coolant is discharged out of the coolant discharge manifold provided in the end plate 26b.

The power generating cells 14 are electrically connected in series with each other, and the generated electric power is created between the terminal bars 66a, 66b constituting both poles of the stack body 14as. The generated electric power is supplied to the control device 12 through each of the high voltage cables 110 connected to the terminal bars 66a, 66b. The voltage is controlled by the control device 12, so that a fuel cell powered vehicle, for example, is brought into a travelable state.

In this case, in this embodiment, as shown in FIGS. 3 and 5, the cable connector 112 connected to the terminal bar 66a is fixedly secured through the fixing member 114 to the temperature controlling plate 24a constituting the end stack member. Therefore, the terminal plate 20a is able to be moved integrally with the temperature controlling plate 24a in relation to the end plate 26a.

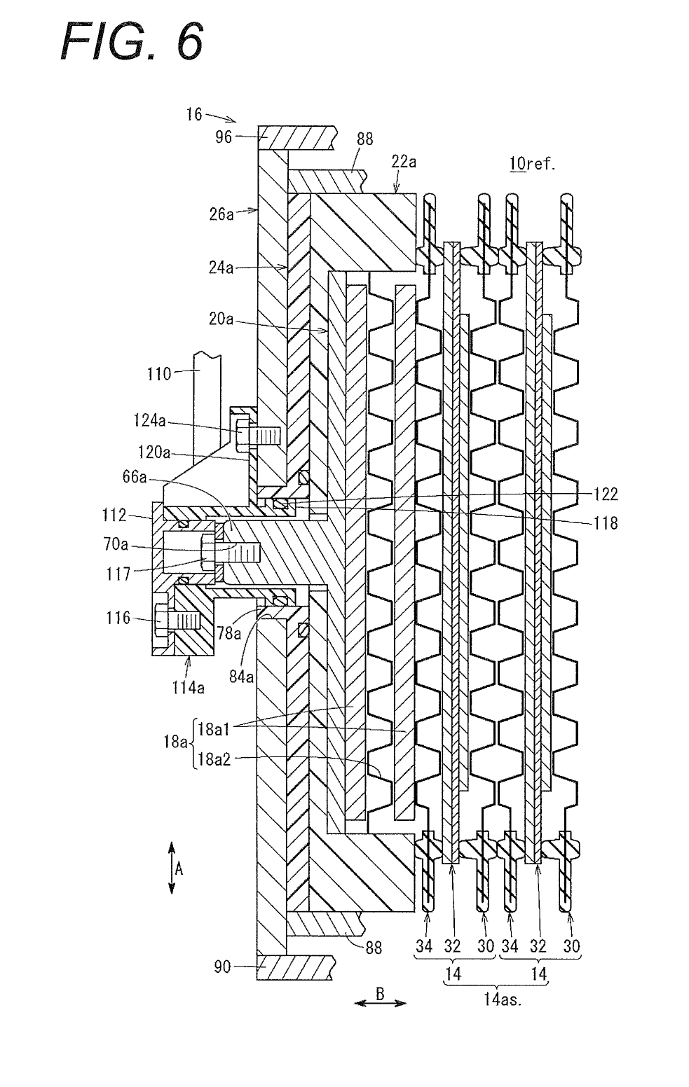

To be specific, the operation and effects of the fuel cell stack 10 will be described hereunder, with reference to a fuel cell stack 10ref. as a comparative example shown in FIG. 6. The fuel cell stack 10ref. is provided with a fixing member 114a, and the fixing member 114a has a mounting plate section 120a. The mounting plate section 120a is secured through a fixing screw 124a to the end plate 26a. In the comparative example, the fixing member 114a is secured directly to the end plate 26a without being secured to the end stack member.

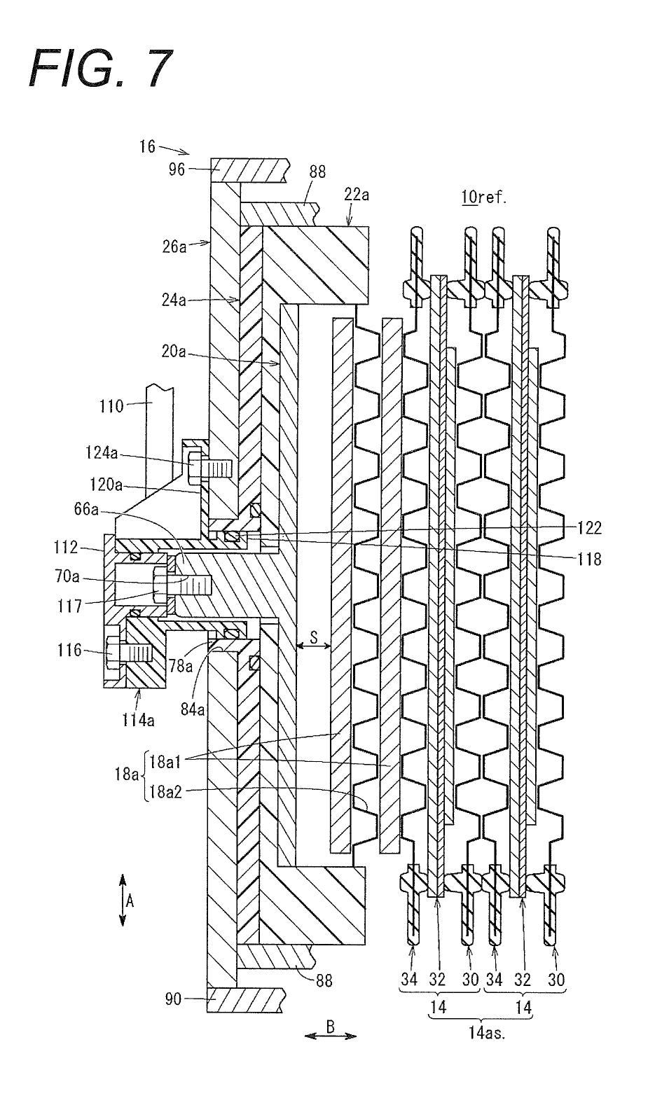

When the external load is applied to the fuel cell stack 10ref., as shown in FIG. 7, the stack body 14as. is easily moved in the stacking direction (the direction of the arrow B) within the housing 16. At that time, the end plates 26a, 26b constitute two sides (surfaces) of the housing 16 in the stacking direction and can be considered as fixed wall surfaces. Therefore, there may be cases where the stack body 14as. is moved relative to the end plates 26a, 26b in the approaching and separating direction.

Herein, the terminal plate 20a is secured to the end plate 26a through the fixing means 114a. Accordingly, when the stack body 14as. and the electroconductive heat insulation member 18a are moved, the electroconductive heat insulation member 18a and the terminal plate 20a are separated apart from each other whereby a gap S is formed. Therefore, in this fuel cell stack 10ref., an electrode surface pressure may be reduced so as to generate a spark, a hydrogen gas leak or the like.

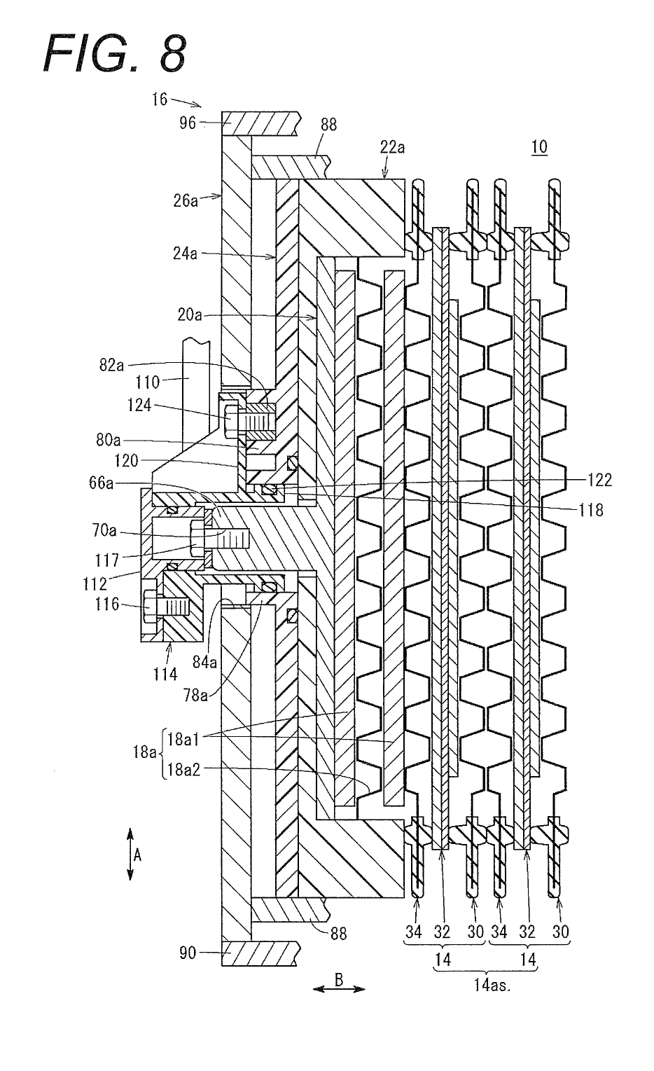

In contrast, in the present embodiment, as shown in FIG. 3, the terminal plate 20a is secured to the temperature controlling plate 24a through the fixing member 114 and can approach to and retreat from the endplate 26a in the stacking direction. Therefore, within the housing 16, the stack body 14as. and the electroconductive heat insulation member 18a are moved in the stacking direction. At that time, as shown in FIG. 8, the terminal plate 20a can be moved integrally with the insulating member 22a and the temperature controlling plate 24a in the stacking direction with respect to the end plate 26a.

Therefore, in this embodiment, when the external load is applied to the fuel cell stack 10, the terminal plate 20a can be moved in accordance with the movement of the power generating cells 14. Accordingly, it is possible to suppress the generation of the spark or the like due to the separation between the terminal plate 20a and the stack body 14as. or the power generating cells 14 constituting the stack body 14as.

Although the cable connector 112 is fixedly secured to the temperature controlling plate 24a in this embodiment, it is not limited to this construction. The cable connector 112 may be fixedly secured to any of the insulating members 22a, 22b, the temperature controlling plates 24a, 24b and the resin plate 29.

A fuel cell stack according to the embodiment of the present invention includes a stack body in which power generating cells configured to generate electric power by electrochemical reaction of fuel gas and oxidant gas are stacked in a plurality of layers. The fuel cell stack has a terminal plate, an end stack member and an end plate which are arranged toward outside in the stacking direction of the stack body.

The terminal plate has a terminal bar which passes through the end plate and extends outwardly in the stacking direction so as to project outwardly from the end plate. A cable connecter connected to the terminal bar is fixedly secured to the end stack member through a fixing member.

Further, it is preferable that in the fuel cell stack, the end stack member includes a plurality of electrically insulating plates which are located between the terminal plate and the end plate.

Further, it is preferable that in the fuel cell stack, the cable connector is fixedly secured to the electrically insulating plate closest to the end plate, among the plurality of electrically insulating plates.

According to the embodiment of the present invention, the cable connecter connected to the terminal bar is fixedly secured to the end stackmember through the fixing member, so that the terminal plate can be moved integrally with the end stack member in the stacking direction in relation to the end plate. Therefore, the terminal plate can be moved in accordance with the movement of the power generating cells, when the external load, especially, such as the inertia force is applied thereto. Accordingly, it is possible to suppress the generation of the spark or the like due to the separation between the terminal plate and the stack body or the power generating cells which constitute the stack body.

Obviously, numerous modifications and variations of the present invention are possible in light of the above teachings. It is therefore to be understood that within the scope of the appended claims, the invention may be practiced otherwise than as specifically described herein.

What is claimed is:

1. A fuel cell stack comprising a stack body in which power generating cells configured to generate power by electrochemical reaction of fuel gas and oxidant gas are stacked in a plurality of layers, a terminal plate, an end stack member and an end plate which are arranged toward outside in the stacking direction of the stack body, wherein the terminal plate has a terminal bar which passes through the endplate and extends outwardly in the stacking direction so as to project outwardly of the end plate, and wherein a fixing member is provided to fixedly secure a cable connecter connected to the terminal bar, to the end stack member.

2. A fuel cell stack according to claim 1, wherein the end stack member comprises a plurality of electrically insulating plates which are located between the terminal plate and the end plate.

3. A fuel cell stack according to claim 2, wherein the cable connector is fixedly secured to the electrically insulating plate closest to the end plate, among the plurality of electrically insulating plates.

4. A fuel cell stack comprising:
a stack body having an end portion in a stacking direction and comprising:
power generating cells stacked in the stacking direction and configured to generate power via electrochemical reaction of fuel gas and oxidant;
an end plate;
an end stack member provided between the end plate and the end portion of the stack body in the stacking direction;
a terminal plate provided between the end stack member and the end portion of the stack body in the stacking direction to be in contact with the end portion of the stack body, the terminal plate including a terminal bar which passes through the end stack member and the end plate and which has a projecting portion projecting from the end plate to be connected to a cable connecter; and
a fixing member to connect the cable connecter to the end stack member.

5. A fuel cell stack according to claim 4, wherein the end stack member comprises a plurality of electrically insulating plates which are located between the terminal plate and the end plate.

6. A fuel cell stack according to claim 5, wherein the cable connector is fixedly secured to the electrically insulating plate closest to the end plate, among the plurality of electrically insulating plates.
